(19) United States
(12) Patent Application Publication
(10) Pub. No.: US 2002/0171973 A1
(43) Pub. Date: Nov. 21, 2002

(54) Cartridge retention and ejection assembly for storage drive

(76) Inventor: Michael Paul Nelson, Kaysville, UT (US)

Correspondence Address: Woodcock Washburn Kurtz, Mackiewicz & Norris LLP, One Liberty Place - 46th Floor, Philadelphia, PA, 19103, US

(21) Appl. No.: 09/858,674

(22) Filed: May 16, 2001

(51) Int. Cl. G11B 17/04

(52) U.S. Cl. 360/99.06

(57) ABSTRACT

A storage drive has a cartridge retention and ejection assembly for receiving and retaining a storage cartridge therein and for ejecting the retained cartridge. In the assembly, a rotatable member rotates on an axis between a first position and a second position, and is biased to the first position. The member includes a base with the axis and a cartridge-contacting arm extending from the base. The member is arranged in the drive such that a cartridge received within the drive contacts the cartridge-contacting arm and thereby rotates the member from the first position to the second position. Releasing the rotatable member from the second position to the first position causes the cartridge-contacting arm of the member to forcibly push against the cartridge and eject same from the drive.

### CROSS-REFERENCE TO RELATED APPLICATIONS

The present application is related to U.S. patent application Ser. No. 09/417,646, filed Oct. 14, 1999 and entitled “CARTRIDGE RETENTION AND EJECTION ASSEMBLY FOR DISK DRIVE”, hereby incorporated by reference in its entirety.

### FIELD OF THE INVENTION

The present invention relates to a cartridge retention and ejection assembly in a storage drive for receiving a cartridge thereinto, retaining the received cartridge, and ejecting the retained cartridge therefrom. More particularly, the present invention relates to a simplified cartridge retention and ejection assembly in a disk drive.

### BACKGROUND OF THE INVENTION

A storage drive for receiving a removable storage cartridge is known. Examples of such a storage drive include a conventional 3.5 inch ‘floppy’ disk drive, a “ZIP” disk drive as developed and marketed by IOMEGA Corporation of Roy, Utah, and the like. Such a storage drive is typically coupled to a processor or the like, and facilitates an exchange of information between the processor and a storage media contained within the storage cartridge. The storage media and the storage drive may be magnetically or optically based, for example, and may be disk or tape based, for example.

In the case of a disk cartridge, such disk cartridge typically includes an outer casing or shell that houses a disk therein. The disk is mounted on a hub or defines a coaxial aperture and can rotate freely within the cartridge. Typically, a complementary disk drive includes a motor which engages the hub or aperture of the disk and applies a rotating force thereto. The outer shell has an aperture at an edge thereof (at least in the case of a “ZIP” disk as developed and marketed by IOMEGA Corporation of Roy, Utah for use in connection with the aforementioned “ZIP” disk drive), and the disk drive includes at least one read/write head that is brought into close proximity to the disk in the disk cartridge by way of the aperture for purposes of reading data from the disk and/or writing data to the disk. A shutter may be provided to cover the aperture when the disk cartridge is removed from the disk drive. Such disk drive may include a shutter opening feature for automatically opening the shutter upon inserting the disk cartridge into the disk drive.

In a relatively sophisticated drive such as the aforementioned “ZIP” disk drive, it is desirable to include an electronically actuatable disk cartridge ejection feature. Accordingly, ejection of the disk cartridge merely requires an appropriate electronic command, originating either from the processor coupled to the disk drive or from the disk drive itself. Of course, prior to disk cartridge ejection, the read/write head(s) of the disk drive are retracted from the disk inside the disk cartridge to a retracted position where ejection of the disk cartridge will not harm or destroy the sensitive head(s).

In the case of the aforementioned “ZIP” disk drive an assembly is provided for receiving the disk cartridge, retaining the received cartridge, and ejecting the retained disk cartridge upon actuation of an actuation unit. However, a current version of such cartridge retention and ejection assembly is somewhat complicated and therefore relatively expensive to manufacture.

A need exists, then, for such a cartridge retention and ejection assembly that is simpler and that is therefore relatively inexpensive to manufacture.

### SUMMARY OF THE INVENTION

The present invention satisfies the aforementioned need by providing a storage drive comprising a cartridge retention and ejection assembly for receiving and retaining a storage cartridge therein and for ejecting the retained cartridge. The cartridge includes a storage media therein for writing data thereto/reading data therefrom by the drive. In the cartridge retention and ejection assembly, a rotatable member rotates on an axis between a cartridge-receiving/-ejecting position and a cartridge-retaining position, and is biased to the cartridge-receiving/-ejecting position. The member includes a base with the axis, a cartridge-contacting arm extending from the base, a ratchet arm extending from the base, and a slot within and defined by the base. The member is arranged in the drive such that a cartridge received within the drive contacts the cartridge-contacting arm and thereby rotates the member from the cartridge-receiving/-ejecting position to the cartridge-retaining position.

A drag link is linearly movable between a cartridge-receiving/ejecting position and a cartridge-retaining position; and is biased to the cartridge-retaining position. The drag link includes a projection complementary to and shaped to fit within the slot of the rotatable member. The drag link and the member are arranged with respect to each other such that rotation of the member from the cartridge-receiving/-ejecting position to the cartridge-retaining position allows the projection of the drag link to move into the slot and the drag link to move from the cartridge-receiving/-ejecting position to the cartridge-retaining position.

A ratchet is linearly movable between a cartridge-receiving/-ejecting position and a cartridge-retaining position, and is biased to the cartridge-receiving/-ejecting position. The ratchet includes a tooth and a latch, each on a lateral side thereof. The member and the ratchet are arranged with respect to each other such that upon insertion of a cartridge into the drive and rotation of the member from the cartridge-receiving/-ejecting position to the cartridge-retaining position, the ratchet arm of the member rotates into contact with the tooth of the ratchet and moves the ratchet from the cartridge-receiving/-ejecting position to the cartridge-retaining position.

An actuator is movable from a first position to a second position, and includes a distally positioned catch. The ratchet and the actuator are arranged with respect to each other such that with the actuator in the first position, movement of the ratchet from the cartridge-receiving/-ejecting position to the cartridge-retaining position causes the catch to retain the ratchet at the latch.

The drag link further includes a ratchet arm extending toward the ratchet and the ratchet further includes a drag link arm extending toward the drag link. The ratchet and the drag link are arranged with respect to each other such that upon moving the actuator from the first position to the second position, the catch is withdrawn from the latch. The ratchet thus moves from the cartridge-retaining position to the cartridge-receiving/-ejecting position, and in doing so the drag link arm of the ratchet contacts the ratchet arm of the drag link and moves the drag link from the cartridge-retaining position to the cartridge-receiving/-ejecting position.

The movement of the drag link from the cartridge-retaining position to the cartridge-receiving/-ejecting position withdraws the projection of the drag link from the slot of the rotatable member. The rotatable member thereby rotates from the cartridge-retaining position to the cartridge-receiving/-ejecting position and the cartridge-contacting arm of the member forcibly pushes against the cartridge and ejects such cartridge from the drive.

### BRIEF DESCRIPTION OF THE DRAWINGS

The foregoing summary as well as the following detailed description of the present invention will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a diagrammatic view of the interior of a storage drive, and shows a cartridge retention and ejection assembly for receiving, retaining, and ejecting a complementary storage cartridge in accordance with one embodiment of the present invention, where the assembly is receiving and ready to retain the cartridge; and

FIG. 2 is a diagrammatic view of the interior of the storage drive and cartridge retention and ejection assembly of FIG. 1, where the assembly is retaining and ready to eject the cartridge.

### DETAILED DESCRIPTION OF THE PREFERRED EMBODIMENT

Certain terminology may be used in the following description for convenience only and is not considered to be limiting. For example, the words “left”, “right”, “upper”, and “lower” designate directions in the drawings to which reference is made. Likewise, the words “inwardly” and “outwardly” are directions toward and away from, respectively, the geometric center of the referenced object. The terminology includes the words above specifically mentioned, derivatives thereof, and words of similar import.

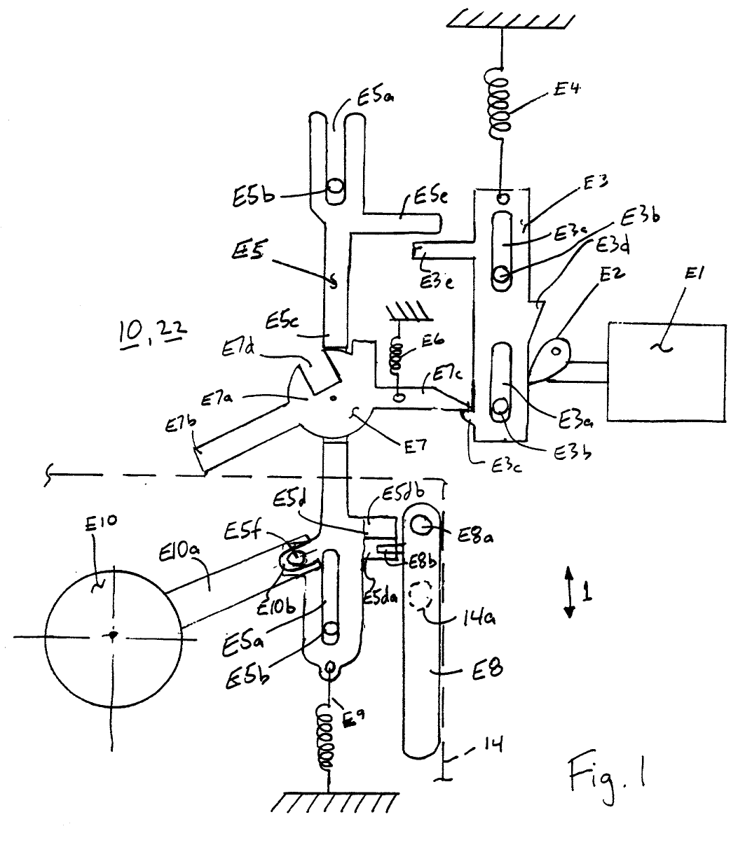

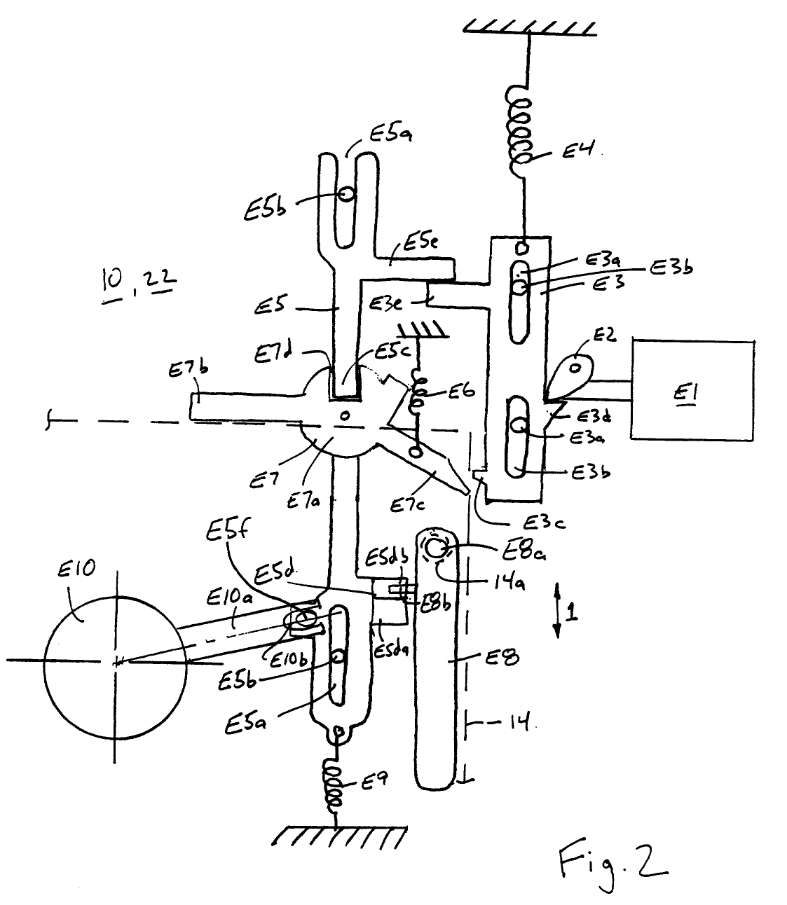

Referring now to the drawings, wherein like numerals are used to indicate like elements throughout, there is shown in FIGS. 1 and 2 a storage drive 10 in accordance with one embodiment of the present invention. As may be appreciated, the storage drive 10 has a frame (not shown) for receiving and retaining a generally planar storage cartridge 14 therein. The drive 10 and cartridge 14 may be of any particular complementary design without departing from the spirit and scope of the present invention. For example, the drive 10 may be designed to receive and retain a conventional 3.5 inch ‘floppy’ disk cartridge 14, a “ZIP” disk cartridge 14 as developed and marketed by IOMEGA Corporation of Roy, Utah, or the like. In any event, the cartridge 14 when received into the drive 10 moves along line 1 within the drive 10.

As was discussed above, the cartridge 14 may include a disk therein, where the disk is employed to store information thereon in a digital form or otherwise. Typically, the drive 10 includes at least one read/write head (not shown) that is to be brought into close proximity to the disk within the cartridge 14 for purposes of reading data from the disk and/or writing data to the disk. The read/write head is generally movable toward and away from the retained disk cartridge 14 and the disk therein by way of an appropriate head assembly (not shown). The structure and operation of such head assembly are generally known and therefore need not be discussed herein in any detail.

As should be understood, the disk within the retained cartridge 14 is to be rotated about a first axis generally perpendicular to the generally planar extent of the drive 10 and cartridge 14 and with respect to the head so that reading data from and/or writing data to the disk may occur. The disk and the disk drive 10 may be magnetically based, optically based, or otherwise based without departing from the spirit and scope of the present invention. In the case of the aforementioned “ZIP” disk and drive, information is stored by the disk drive 10 onto the disk in a magnetic form.

In one embodiment of the present invention, the drive 10 includes a cartridge retention and ejection assembly 22 to receive the cartridge 14 thereinto and be ready to retain the received cartridge 14 (FIG. 1), and to retain the received cartridge 14 and be ready to eject the retained cartridge 14 (FIG. 2). The cartridge retention and ejection assembly 22 includes a rotatable member E7 that is generally rotatable along an axis generally parallel to the first axis about which the disk within the retained cartridge 14 is to be rotated. As shown, the member E7 rotates between a cartridge-receiving/-ejecting position (FIG. 1) and a cartridge-retaining position (FIG. 2). The member E7 is biased to the cartridge-receiving/ejecting position by a biasing device E6 such as a spring, although other biasing devices may be employed without departing from the spirit and scope of the present invention.

The member E7 includes a centrally located base E7a which includes the axis, and a cartridge-contacting arm E7b and a ratchet arm E7c, each of which extends generally radially from such base E7a. In addition, the member E7 includes a slot E7d as defined by the base E7a. Importantly, upon insertion of a cartridge 14 into the drive, the cartridge 14 contacts the cartridge-contacting arm E7b of the member E7, and upon exertion of an amount of force upon the cartridge 14 and therefore upon the cartridge-contacting arm E7b, the member E7, the cartridge 14 rotates from the cartridge-receiving/-ejecting position (FIG. 1) to the cartridge-retaining position (FIG. 2) against the spring E6.

The cartridge retention and ejection assembly 22 also includes a drag link E5 which is generally linearly movable along line 1 generally parallel to but opposite movement of the cartridge 14 during reception and ejection thereof. As shown, the drag link E5 moves between a cartridge-receiving/-ejecting position (FIG. 1) and a cartridge-retaining position (FIG. 2). The drag link E5 is biased to the cartridge-retaining position by a biasing device E9 such as a spring, although other biasing devices may be employed without departing from the spirit and scope of the present invention.

As seen, one of the drag link E5 and the frame of the drive 10 includes a pair of guide slots E5a each extending generally along the line 1. As seen, each guide slot E5a receives a guide pin E5b fixedly mounted to the other of the drag link E5 and the frame of the drive 10. Accordingly, the guide slots E5a and guide pins E5b restrict linear movement of the drag link E5 within a predefined range. As shown, the drag link E5 includes the pair of guide slots E5a, and the guide pins E5b are fixedly mounted to the frame of the drive 10.

The drag link E5 also includes a projection E5c complementary to and shaped to fit within the slot E7d of the rotatable member E7. Preferably, and as seen, the drag link E5 and the member E7 are arranged with respect to each other such that the projection E5c moves into and fits within the slot E7d upon proper rotational orientation of the member E7 with respect to the drag link E5. As shown, the projection E5c is generally in-line with the linear extent of the drag link E5, the slot E7d extends generally radially with respect to the member E7, and the linear extent of the drag link E5 generally intersects the axis of the member E7.

Importantly, upon insertion of a cartridge 14 into the drive and rotation of the member E7 from the cartridge-receiving/-ejecting position (FIG. 1) to the cartridge-retaining position (FIG. 2) against the spring E6, the projection E5c of the drag link E5 in fact moves into and fits within the slot E7d of the member E7, and the drag link E5 thus moves from the cartridge-receiving/-ejecting position (FIG. 1) to the cartridge-retaining position (FIG. 2) under the bias of the spring E9.

In one embodiment of the present invention, the drive 10 includes a cartridge retainer E8 having a cartridge retention pin E8a mounted thereto for cooperating with a retention aperture 14a in the cartridge 14 to retain the received cartridge 14. The cartridge retention pin E8a is movable in a line generally parallel to the first axis between a cartridge-receiving/-ejecting position corresponding to FIG. 1 and a cartridge-retaining position corresponding to FIG. 2. Although the cartridge retention pin E8a as shown cooperates with the retention aperture 14a in the cartridge 14, alternate devices may be employed in the cartridge retainer E8 without departing from the spirit and scope of the present invention. For example, the assembly E8 may include a blocking device moved in front of the proximal edge of the cartridge 14 to prevent the cartridge 14 from ejecting from the disk drive 10.

As shown, a ramp E5d is mounted to one of the drag link E5 and the cartridge retainer E8, and has a cartridge-receiving/-ejecting level E5da and a cartridge-retaining level E5db with respect to a line generally parallel to the first axis. Correspondingly, a ramp-engaging device E8b is mounted to the other of the drag link E5 and the cartridge retainer E8, and is in cooperative contact with the ramp E5d such that the ramp-engaging device E8b contacts the cartridge-receiving/-ejecting level E5da when the drag link E5 is in the cartridge-receiving/-ejecting position (FIG. 1), and contacts the cartridge-retaining level E5db when the drag link E5 is in the cartridge-retaining position (FIG. 2). As seen in the drawings, the ramp E5d is mounted to the drag link E5 and the ramp-engaging device E8b is mounted to the cartridge retainer E8.

In one embodiment of the present invention, the ramp-engaging device E8b is a pin that follows along one side of the ramp E5d. In such situation, the cartridge retainer and pin E8, E8a should be biased to either the cartridge-retaining position or the cartridge-receiving/-ejecting position, as appropriate. In another embodiment, the ramp-engaging device E8b includes a first pin engaging a top side of the ramp and a second, generally opposing pin engaging a bottom, opposing side of the ramp. In such situation, biasing is likely not necessary for the cartridge retainer and pin E8, E8a.

Importantly, upon insertion of a cartridge 14 into the drive and movement of the drag link E5 from the cartridge-receiving/-ejecting position (FIG. 1) to the cartridge-retaining position (FIG. 2) under the bias of the spring E9, the ramp-engaging device E8b mounted to the cartridge retainer E8 is moved into contact with the cartridge-receiving/-ejecting level E5da of the ramp E5d of the drag link E5 (FIG. 2). Thus, the cartridge retention pin E8a moves into the retention aperture 14a in the cartridge 14 to retain the received cartridge 14 within the drive 10.

In one embodiment of the present invention, the drive 10 includes a disk motor E10 mounted thereto for rotating the disk within the disk cartridge 14. As was disclosed above, the disk includes a hub, and the motor E10 and hub are brought into contact to allow the motor E10 to impart rotational force to such hub and the disk. Operation of the motor E10, the design of the motor E10 and the hub, and the interaction therebetween are generally known and therefore need not be described herein in any further detail.

In one embodiment of the present invention, the motor E10 is moved into contact with the disk in a direction generally perpendicular to the plane of such disk. Moreover, such movement of such motor E10 is actuated as part of retaining the disk cartridge 14 in the drive 10. Accordingly, the motor E10 is movable between a disk-engagement position (FIG. 2) and a disk-separation position (FIG. 1). Such motor E10 is biased to the disk-engagement position by a biasing device such as the spring E9 associated with the drag link, although other biasing devices may be employed without departing from the spirit and scope of the present invention.

In one embodiment of the present invention, the disk motor E10 is helically mounted to the frame of the drive 10, and thus moves in a helical manner about the first axis between the disk-engagement position and the disk-separation position and into contact with the disk to rotate such disk. That is to say, rotation of the body of the motor E10 about the first axis achieves displacement of such motor E10 along such first axis. The motor E10 may be any appropriate motor and the helical mount may be any appropriate helical mount without departing from the spirit and scope of the present invention as long as such motor E10 is suitable for the purpose of rotating the disk at a suitable speed and such helical mount is suitable for the purpose of achieving contact between the motor E10 and the disk in a given amount of rotation. Disk motors and helical mounts are generally known and therefore need not be further described herein in detail.

The motor includes a motor lever E10a that extends generally radially from the first axis and that has a shaped slot E10b at a distal end thereof. The motor lever E10a is fixed with respect to the motor E10 and is thus rotatable on the first axis between a cartridge-receiving/-ejecting position (FIG. 1) and a cartridge-retaining position (FIG. 2). As with the motor E10, the motor lever E10a may be biased to the cartridge-retaining position by a biasing device such as the spring E9 associated with the drag link, although other biasing devices may be employed without departing from the spirit and scope of the present invention.

The drag link E5 also includes a motor lever pin E5f that co-acts with the motor lever E10a of the motor E1. Preferably, and as seen, the drag link E5 and the motor E10 are arranged with respect to each other such that the pin E5f is received by the shaped slot E10b of the motor lever E10a, whereby the shaped slot E10b and the motor lever pin E5f co-act to rotate the motor lever E10a and motor E10 according to the liner movement of the drag link E5. At the same time, such shaped slot E10b and such motor lever pin E5f co-act to restrict rotational movement of the motor lever E10a within a range defined by the stroke of the drag link E5.

Importantly, upon insertion of a cartridge 14 into the drive and movement of the drag link E5 from the cartridge-receiving/-ejecting position (FIG. 1) to the cartridge-retaining position (FIG. 2) under the bias of the spring E9, the motor lever pin E5f of the drag link moves the motor lever E10a from the cartridge-receiving/-ejecting position (FIG. 1) to the cartridge-retaining position (FIG. 2) and correspondingly moves the motor E10 from the disk-separation position (FIG. 1) to the disk-engagement position (FIG. 2).

The cartridge retention and ejection assembly 22 also includes a ratchet E3 which, like the drag link E5 is generally linearly movable along line 1 generally parallel to but opposite movement of the cartridge 14 during reception and ejection thereof. As shown, the ratchet E3 moves between a cartridge-receiving/-ejecting position (FIG. 1) and a cartridge-retaining position (FIG. 2). The ratchet E3 is biased to the cartridge-receiving/-ejecting position by a biasing device E4 such as a spring, although other biasing devices may be employed without departing from the spirit and scope of the present invention.

As seen, one of the ratchet E3 and the frame of the drive 10 includes a pair of guide slots E3a each extending generally along the line 1. As seen, each guide slot E3a receives a guide pin E3b fixedly mounted to the other of the ratchet E3 and the frame of the drive 10. Accordingly, the guide slots E3a and guide pins E3b restrict linear movement of the ratchet E3 within a pre-defined range. As shown, the ratchet E3 includes the pair of guide slots E3a, and the guide pins E3b are fixedly mounted to the frame of the drive 10.

The ratchet E3 also includes a tooth E3c and a ramp E3d, each on a lateral side thereof. Preferably, and as seen, the member E7 and the ratchet E3 are arranged with respect to each other such that the ratchet arm E7c upon rotation of the member E7 contacts the tooth E3c and moves the ratchet E3 toward the cartridge-retaining position of FIG. 2.

In particular, and importantly, upon insertion of a cartridge 14 into the drive and rotation of the member E7 from the cartridge-receiving/-ejecting position (FIG. 1) to the cartridge-retaining position (FIG. 2) against the spring E6, the ratchet arm E7c of the member E7 in fact rotates into contact with the tooth E3c of the ratchet E3 and in fact moves the ratchet E3 from the cartridge-receiving/-ejecting position (FIG. 1) to the cartridge-retaining position (FIG. 2) against the bias of the spring E4.

Preferably, the rotating ratchet arm E7c moves the ratchet E3 past the cartridge-retaining position to allow such rotating ratchet arm E7c to move past the tooth E3c. Upon the ratchet arm E7c in fact moving past the tooth E3c, the ratchet E3 slips back to the cartridge-retaining position and is held in the cartridge-retaining position by way of the ramp E3d.

In one embodiment of the present invention, the cartridge retention and ejection assembly 22 also includes a selectively actuatable actuator E1 movable from a first position (FIGS. 1 and 2) to a second position to actuate ejection of a retained cartridge 14. In one embodiment of the present invention, the actuator E1 is a solenoid having a plunger, where the plunger is generally linearly movable between an extended (first) position (FIGS. 1 and 2) and a plunged (second) position. As may be appreciated, the plunger of the solenoid E1 may be biased to the extended position, and plunges an increasing depth corresponding to an increasing voltage and/or current applied to the solenoid coils. Since solenoids and the operation thereof are generally known, further discussion in this regard is deemed unnecessary. Of course, the solenoid E1 may be configured alternately, and actuators E1 other than a solenoid maybe employed, all without departing from the spirit and scope of the present invention. For example, the solenoid E1 may be biased to the fully plunged position, or a rotary motor may be employed if appropriately configured.

In one embodiment of the present invention, the solenoid E1 includes a rotatable pawl E2 at the distal end of the plunger thereof. Preferably, the ratchet E3 and the solenoid E1 with the pawl E2 are arranged with respect to each other such that, with the plunger of the solenoid E1 in the first, extended position, movement of the ratchet E3 from the cartridge-receiving/-ejecting position (FIG. 1) toward and past the cartridge-retaining position (FIG. 2) allows the pawl E2 at the end of the plunger to contact the angled surface of the ramp E3d and rotate past such ramp E3d. Importantly, upon the ratchet arm E7c in fact moving past the tooth E3c, the ratchet E3 slips back to the cartridge-retaining position and is held in the cartridge-retaining position against the spring E4 by way of the pawl E2 resting against the wall surface of the ramp E3d, as shown in FIG. 2.

In one embodiment of the present invention, the drag link E5 includes a ratchet arm E5e that extends generally toward the ratchet E3, and the ratchet E3 likewise includes a drag link arm E3e that extends generally toward the drag link E5. Preferably, the ratchet E3 and the drag link E5 are arranged with respect to each other such that upon actuating the solenoid E1, the plunger moves to the second, plunged position and allows the ratchet E3 to move from the cartridge-retaining position (FIG. 2) to the cartridge-receiving/-ejecting position (FIG. 1) under the bias of the spring E4, and in doing so the drag link arm E3e of the ratchet E3 contacts the ratchet arm E5e of the drag link E5. Importantly, such contact causes the drag link E5 to move from the cartridge-retaining position (FIG. 2) to the cartridge-receiving/-ejecting position (FIG. 1) against the spring E9. Preferably, the force exerted by spring E4 is greater than the force exerted by spring E9.

As may now be appreciated, upon the drag link E5 moving from the cartridge-retaining position (FIG. 2) to the cartridge-receiving/-ejecting position (FIG. 1) against the spring E9, the ramp E5d of the drag link E5 moves with respect to the ramp-engaging device E8b of the cartridge retainer E8 such that the ramp-engaging device E8b contacts the ramp E5d at the cartridge-receiving/-ejecting level E5da. Accordingly, the cartridge retention pin E8a is moved from the cartridge-retaining position (FIG. 2) to the cartridge-receiving/-ejecting position (FIG. 1) and frees the retained cartridge 14.

Substantially simultaneously, upon the drag link E5 moving from the cartridge-retaining position (FIG. 2) to the cartridge-receiving/-ejecting position (FIG. 1) against the spring E9, the motor lever pin E5f of the drag link moves the motor lever E10a from the cartridge-retaining position (FIG. 2) to the cartridge-receiving/-ejecting position (FIG. 1). Accordingly, the motor E10 correspondingly moves from the disk-engagement position (FIG. 2) to the disk-separation position (FIG. 1) and disengages from the disk within the retained cartridge 14. Thus, the disk cartridge 14 is freely ejectable from the drive 10 without interference or blockage by such motor E10.

Also substantially simultaneously, upon the drag link E5 moving from the cartridge-retaining position (FIG. 2) to the cartridge-receiving/-ejecting position (FIG. 1) against the spring E9, the projection E5c of the drag link E5 is withdrawn from the slot E7d of the rotatable member E7. Thus, the rotatable member E7 under the bias of the spring E5 rotates from the cartridge-retaining position (FIG. 2) to the cartridge-receiving/-ejecting position (FIG. 1). In doing so, the cartridge-contacting arm E7b of the member E7 forcibly pushes against the freed cartridge 14 having the disengaged disk and in fact ejects such cartridge 14 from the drive 10.

When the member E7 rotates to the cartridge-receiving/-ejecting position (FIG. 1) to eject the cartridge 14, the ratchet arm E7c thereof must clear the tooth E3c of the ratchet E3. That is, the tooth E3c would seem to block the rotating ratchet arm E7c absent any diverting structure. In one embodiment of the present invention, then, the tooth E3c is provided with an incline plane and the incline plane causes the ratchet arm e7c to slide up/down and out of plane in the course of passing the tooth E3c, thereby in fact allowing the ratchet arm E7c to clear the tooth E3c of the ratchet E3 when the member E7 rotates to the cartridge-receiving/-ejecting position (FIG. 1) to eject the cartridge 14.

In the foregoing description, it can be seen that the present invention comprises a new and useful storage drive 10 having a simple and inexpensive cartridge retention and ejection assembly 22 that receives a storage cartridge 14, retains the received cartridge 14, and ejects the retained cartridge 14 upon actuation of an actuation unit E1. It should be appreciated that changes could be made to the embodiments described above without departing from the inventive concepts thereof. For example, the cartridge 14 may contain an item other than a disk, such as for example a tape. It should be understood, therefore, that this invention is not limited to the particular embodiments disclosed, but it is intended to cover modifications within the spirit and scope of the present invention as defined by the appended claims.

1. A storage drive comprising a cartridge retention and ejection assembly for receiving and retaining a storage cartridge therein and for ejecting the retained cartridge, the cartridge including a storage media therein for writing data thereto/reading data therefrom by the drive, the cartridge retention and ejection assembly comprising a rotatable member generally rotatable on an axis between a cartridge-receiving/-ejecting position and a cartridge-retaining position, the member being biased to the cartridge-receiving/-ejecting position, the member including a base with the axis and a cartridge-contacting arm extending from the base, the member being arranged in the drive such that a cartridge received within the drive contacts the cartridge-contacting arm and thereby rotates the member from the cartridge-receiving/-ejecting position to the cartridge-retaining position, the rotatable member upon being released from the cartridge-retaining position to the cartridge-receiving/-ejecting position causing the cartridge-contacting arm of the member to forcibly push against the cartridge and eject such cartridge from the drive.

2. The storage drive of claim 1 wherein the rotatable member further includes a ratchet arm extending from the base and a slot within and defined by the base, and wherein the cartridge retention and ejection assembly further comprises:
a drag link generally linearly movable between a cartridge-receiving/-ejecting position and a cartridge-retaining position; the drag link being biased to the cartridge-retaining position, the drag link including a projection complementary to and shaped to fit within the slot of the rotatable member, the drag link and the member being arranged with respect to each other such that rotation of the member from the cartridge-receiving/-ejecting position to the cartridge-retaining position allows the projection of the drag link to move into the slot and the drag link to move from the cartridge-receiving/-ejecting position to the cartridge-retaining position;
a ratchet generally linearly movable between a cartridge-receiving/-ejecting position and a cartridge-retaining position, the ratchet being biased to the cartridge-receiving/-ejecting position, the ratchet including a tooth and a latch, each on a lateral side thereof, the member and the ratchet being arranged with respect to each other such that upon insertion of a cartridge into the drive and rotation of the member from the cartridge-receiving/-ejecting position to the cartridge-retaining position, the ratchet arm of the member rotates into contact with the tooth of the ratchet and moves the ratchet from the cartridge-receiving/-ejecting position to the cartridge-retaining position; and
an actuator movable from a first position to a second position, the actuator including a distally positioned catch, the ratchet and the actuator being arranged with respect to each other such that with the actuator in the first position, movement of the ratchet from the cartridge-receiving/-ejecting position to the cartridge-retaining position causes the catch to retain the ratchet at the latch,
the drag link further including a ratchet arm extending generally toward the ratchet and the ratchet further including a drag link arm extending generally toward the drag link, the ratchet and the drag link being arranged with respect to each other such that upon moving the actuator from the first position to the second position, the catch is withdrawn from the latch, the ratchet moves from the cartridge-retaining position to the cartridge-receiving/-ejecting position, and in doing so the drag link arm of the ratchet contacts the ratchet arm of the drag link and moves the drag link from the cartridge-retaining position to the cartridge-receiving/-ejecting position,
the movement of the drag link from the cartridge-retaining position to the cartridge-receiving/-ejecting position withdrawing the projection of the drag link from the slot of the rotatable member, the rotatable member thereby rotating from the cartridge-retaining position to the cartridge-receiving/-ejecting position and the cartridge-contacting arm of the member forcibly pushing against the cartridge and ejecting such cartridge from the drive.

3. The drive of claim 2 wherein the rotating ratchet arm moves the ratchet past the cartridge-retaining position to allow such rotating ratchet arm to move past the tooth, and wherein upon the ratchet arm moving past the tooth, the ratchet slips back to the cartridge-retaining position and is retained in the cartridge-retaining position by way of the ramp and the catch.

4. The drive of claim 2 wherein the latch comprises a ramp and the catch comprises a rotatable pawl.

5. The drive of claim 2 further comprising a cartridge retainer having a cartridge retention pin generally movable between a cartridge-receiving/-ejecting position and a cartridge-retaining position, the cartridge retention pin for cooperating with a retention aperture in the cartridge to retain same within the drive, the drag link and the cartridge retainer being arranged with respect to one another such that movement of the drag link from the cartridge-receiving/-ejecting position to the cartridge-retaining position causes the cartridge retention pin to move from the cartridge-receiving/-ejecting position to the cartridge-retaining position.

6. The drive of claim 5 wherein one of the drag link and the cartridge retainer has a ramp and the other of the drag link and the cartridge retainer has a ramp-engaging device in cooperative contact with the ramp such that the ramp-engaging device contacts the ramp at a first level when the drag link is in the cartridge-receiving/-ejecting position and contacts the ramp at a second level when the drag link is in the cartridge-retaining position.

7. The drive of claim 6 wherein movement of the drag link from the cartridge-retaining position to the cartridge-receiving/-ejecting position moves the ramp with respect to the ramp-engaging device such that the ramp-engaging device contacts the ramp at the first level and the cartridge retention pin is moved from the cartridge-retaining position to the cartridge-receiving/-ejecting position.

8. The drive of claim 2 further comprising a motor for engaging and rotating an element within the cartridge, the motor being movable between an element-engagement position and an element-separation position, the motor being biased to the disk-engagement position, the drag link and the motor being arranged with respect to one another such that movement of the drag link from the cartridge-receiving/-ejecting position to the cartridge-retaining position causes the motor to move from the element-separation position to the element-engagement position.

9. The drive of claim 8 wherein the motor is helically mounted and includes a generally radially extending motor lever fixed with respect to the motor, and wherein the drag link includes a motor lever engager that co-acts with the motor lever.

10. The drive of claim 9 wherein the motor lever includes a shaped slot at a distal end thereof and wherein the motor lever engager of the drag link is a pin mounted thereto, the pin being received by the shaped slot.

11. The drive of claim 8 wherein movement of the drag link from the cartridge-retaining position to the cartridge-receiving/-ejecting position moves the motor from the disk-engagement position to the disk-separation position.
